(19) United States
(12) Patent Application Publication
(10) Pub. No.: US 2009/0204927 A1
(43) Pub. Date: Aug. 13, 2009

(54) INFORMATION PROCESSING APPARATUS FOR LOCATING AN OVERLAID MESSAGE, MESSAGE LOCATING METHOD, AND MESSAGE LOCATING COMPUTER-READABLE MEDIUM

(75) Inventor: Takashi TERASAKI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/367,608

(22) Filed: Feb. 9, 2009

(30) Foreign Application Priority Data
Feb. 8, 2008 (JP) 2008-029015

(51) Int. Cl. G06F 3/048

(52) U.S. Cl. 715/781; 715/808

(57) ABSTRACT

A computer-implemented method, for selectively locating an overlaid message on a screen of a display apparatus, includes: obtaining notification information that includes an indication of the content of the message to be displayed on a screen of the display apparatus; adaptively selecting an area of the screen to serve as an announcement area for eventual depiction of the message, a location of the announcement area being such that depiction of the message therein is less-likely to disrupt a viewer of the screen than depiction of the message in a work area of the screen for which disruption of the viewer would be more likely; and outputting, to a display apparatus, a control signal indicating the content of the message to be displayed and indicating the announcement area of the screen.

### CROSS-REFERENCE TO RELATED APPLICATIONS

This application is related to and claims priority to Japanese patent application No. 2008-029015 filed on Feb. 8, 2008, in the Japan Patent Office, the entire contents of which are incorporated by reference herein.

### BACKGROUND

The present technique relates to an information processing apparatus, a message providing method, and a message providing program. More specifically, the present technique relates to an information processing apparatus, a message providing method, and a message providing program to provide information to a user.

Under present circumstances, a message is forcibly displayed on an operation screen regardless of an operation status of a user if there is information that should be immediately provided to the user during operation of a computer. For example, a notification that an update of a software program is available, a notification that an e-mail or an instant message has been received, or a warning about a shortage of hardware resources, such as a memory, is displayed as a message on the operation screen.

Typically, such a message display process is performed by combining a message with an operation screen on the computer side and outputting an image signal generated through the combination to a display apparatus. On the other hand, there is a method of inputting a signal corresponding to a message to a display apparatus separately from an image signal and overlaying the message on the screen corresponding to the image signal in the display apparatus (overlay display). By using such an overlay display function of the display apparatus, the following advantages can be obtained: a load of image processing on a computer can be reduced; and a message can be reliably displayed on the other image (on the top layer).

However, in the above-described methods, the area that is currently viewed by a user is hidden by a forcibly-displayed message, whereby work performed by the user can be interrupted disadvantageously. On the other hand, if the area hidden by a message is reduced, the message is displayed in a small size, which causes a problem that the user has difficulty recognizing or reading the message.

### SUMMARY

An embodiment provides a computer-implemented method, for selectively locating an overlaid message on a screen of a display apparatus, that may include: obtaining notification information that includes an indication of the content of the message to be displayed on a screen of the display apparatus; adaptively selecting an area of the screen to serve as an announcement area for eventual depiction of the message, a location of the announcement area being such that depiction of the message therein is less-likely to disrupt a viewer of the screen than depiction of the message in a work area of the screen for which disruption of the viewer would be more likely; and outputting, to a display apparatus, a control signal indicating the content of the message to be displayed and indicating the announcement area of the screen.

Such an embodiment, e.g., addresses shortcomings of the Related Art, and can provide benefits that include suppressing interruption of viewer's work due to display of an overlaid message.

### BRIEF DESCRIPTION OF DRAWINGS

FIG. 1 is a conceptual diagram of an embodiment;

FIG. 2 is hardware configuration diagram of an information processing apparatus of the embodiment;

FIG. 3 is a block diagram illustrating functions of the information processing apparatus;

FIG. 4 illustrates an example of a data structure of a notification information definition table;

FIG. 5 is a schematic diagram illustrating a specific example of screen division;

FIG. 6 illustrates an example of a data structure of a message definition table;

FIG. 7 illustrates an example of a data structure of a pointer position history table;

FIG. 8 is a schematic diagram illustrating a history of pointer positions indicated by a mouse;

FIG. 9 illustrates an example of a data structure of a window display frequency table;

FIG. 10 is a schematic diagram illustrating an example in which a work window is displayed on a screen;

FIG. 11 illustrates an example of a data structure of notification information data;

FIG. 12 is a first flowchart illustrating a procedure of message notification performed by the information processing apparatus;

FIG. 13 is a second flowchart illustrating the procedure of message notification performed by the information processing apparatus;

FIG. 14 is a schematic diagram illustrating an example of a frame configuration based on the MPEG;

FIG. 15 is a schematic diagram illustrating specific examples in which a message is displayed at a fixed position;

FIG. 16 is a schematic diagram illustrating a specific example in which a message is displayed by avoiding a user's work area;

FIG. 17 is a schematic diagram illustrating a specific example in which a message is displayed in an area where window display frequency is low; and

FIG. 18 is a schematic diagram illustrating a specific example in which a message is displayed on a screen where a moving image is being reproduced.

### DESCRIPTION OF EMBODIMENTS

Hereinafter, an embodiment is described in detail with reference to the drawings. An overview of the embodiment is described first, and then the details of the embodiment are described.

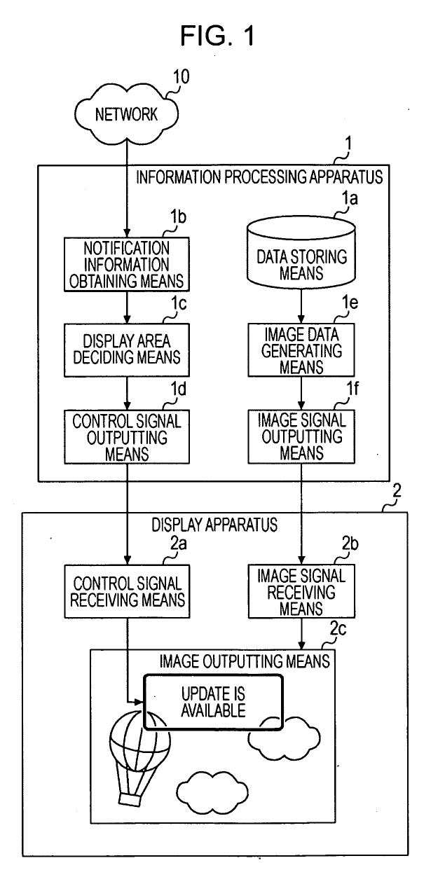

FIG. 1 is a conceptual diagram of the embodiment. An information processing apparatus 1 illustrated in FIG. 1 obtains notification information, such as update information provided by an OS (operating system) or an application, e-mail reception information, and information about a usage status of hardware, and provides the notification information to a user. The information processing apparatus 1 connects to a network 10. Also, the information processing apparatus 1 connects to a display apparatus 2 and allows the display apparatus 2 to display an overlaid message to the user, who is a viewer of the display apparatus.

The information processing apparatus 1 includes data storing means 1a, notification information obtaining means 1b, display area deciding means 1c, control signal outputting means 1d, image data generating means 1e, and image signal outputting means 1f.

The data storing means 1a stores content data of still and moving images.

The notification information obtaining means 1b obtains update information of the OS and applications operating in the information processing apparatus 1 via the network 10. Also, the notification information obtaining means 1b obtains e-mail reception information and information about a usage status of hardware from the OS and applications operating in the information processing apparatus 1.

The display area deciding means 1c decides an output position and/or an announcement area on a screen of the display apparatus 2 of an overlaid message indicating the notification information obtained by the notification information obtaining means 1b. The display area deciding means 1c determines a position where change in the screen is small in the screen area of the display apparatus 2, and decides the determined position to be an output position of a message. The display area deciding means 1c outputs notification information and output position information to the control signal outputting means 1d.

The control signal outputting means 1d converts the notification information and the output position information obtained from the display area deciding means 1c to a control signal for the display apparatus 2. Then, the control signal outputting means 1d outputs the control signal to the display apparatus 2. Here, the control signal for the display apparatus 2 is also used to control, from the information processing apparatus 1, the brightness and tone of an image displayed in the image outputting means 2c of the display apparatus 2, for example.

The image data generating means 1e generates image data of an OS operation screen and a moving image to be displayed in the display apparatus 2 based on the content data stored in the data storing means 1a.

The image signal outputting means 1f converts the image data generated by the image data generating means 1e to an image signal to be displayed in the display apparatus 2. The image signal outputting means 1f outputs the image signal to the display apparatus 2.

The display apparatus 2 includes control signal receiving means 2a, image signal receiving means 2b, and the image outputting means 2c.

The control signal receiving means 2a receives a control signal including notification information from the information processing apparatus 1. The control signal receiving means 2a obtains notification information data from the control signal and outputs it to the image outputting means 2c.

The image signal receiving means 2b receives an image signal from the information processing apparatus 1. The image signal receiving means 2b outputs data of a basic screen, that is, an OS operation screen and image content to be operated/browsed by a user, to the image outputting means 2c based on the received image signal.

The image outputting means 2c is a screen on which images are displayed. The image outputting means 2c displays an image on its screen based on basic screen data from the image signal receiving means 2b. When receiving data including a message representing notification information and a display area for the message from the control signal receiving means 2a, the image outputting means 2c combines the basic screen with the message based on the data so as to perform overlay display. Here, overlay display means a display method for overlaying characters or a figure on a basic screen as a background.

In this way, the information processing apparatus 1 decides an output position of a message in the screen area of the display apparatus 2 when providing a message to a user. The information processing apparatus 1 determines an area where change in the screen is small in the screen area of the display apparatus 2 to be the output position and outputs a control signal to the display apparatus 2 so that the message is output in this area. Accordingly, interruption of work performed by the user due to display of a message can be suppressed.

Hereinafter, the embodiment is described in detail with reference to the drawings.

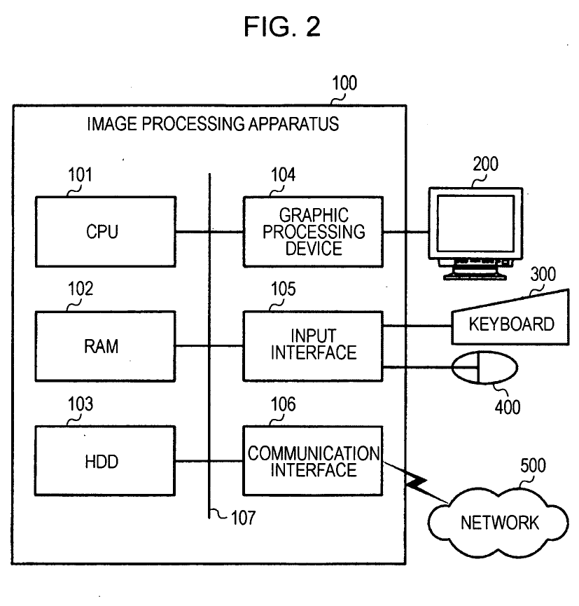

FIG. 2 is a hardware configuration diagram of the information processing apparatus according to the embodiment. The entire image processing apparatus 100 is controlled by a CPU (Central Processing Unit) 101. The CPU 101 connects to a RAN (Random Access Memory) 102, an HDD (Hard Disk Drive) 103, a graphic processing device 104, an input interface 105, and a communication interface 106 through a bus 107.

The RAM 102 temporarily stores at least part of programs and applications of the OS executed by the CPU 101. Also, the RAM 102 stores various data necessary for processes performed by the CPU 101.

The HDD 103 stores data used by the OS and applications on the image processing apparatus 100.

The graphic processing device 104 connects to a monitor 200. The graphic processing device 104 allows the screen of the monitor 200 to display an image in accordance with a command from the CPU 101. The monitor 200 has a function of performing overlay display of characters and a figure on the basic screen of the information processing apparatus 100. The graphic processing device 104 and the monitor 200 connect to each other through a serial communication cable or the like, and control signals and image signals are mutually transmitted/received therebetween.

The input interface 105 connects to a keyboard 300 and a mouse 400. The input interface 105 outputs signals transmitted from the keyboard 300 and the mouse 400 to the CPU 101 through the bus 107.

The communication interface 106 connects to a network 500. The communication interface 106 transmits/receives data to/from another computer via the network 500.

With the above-described hardware configuration, processing functions of the embodiment can be realized. Hereinafter, a functional configuration of the information processing apparatus 100 is described.

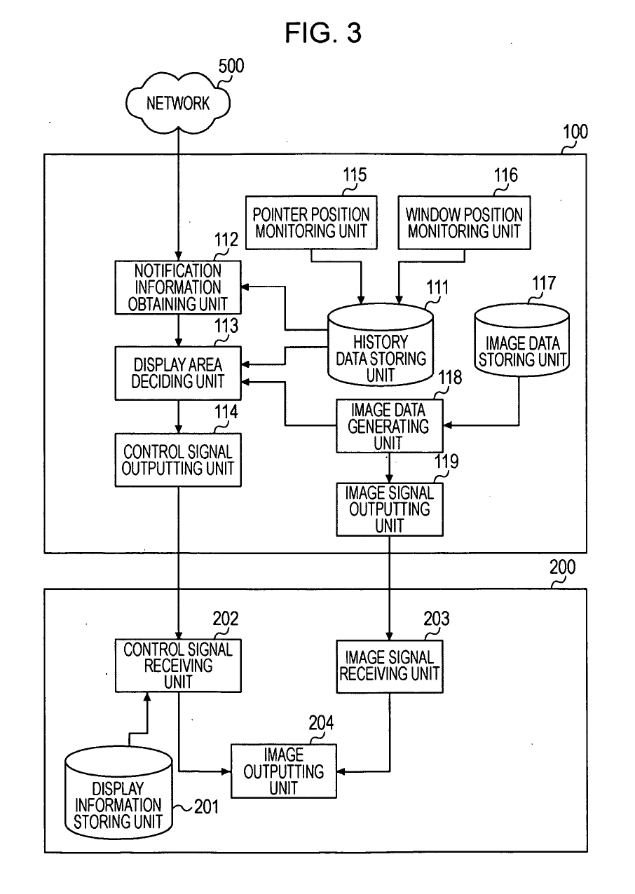

FIG. 3 is a block diagram illustrating functions of the information processing apparatus 100. FIG. 3 also illustrates the network 500 and the monitor 200 connected to the information processing apparatus 100.

The information processing apparatus 100 includes a history data storing unit 111, a notification information obtaining unit 112, a display area deciding unit 113, a control signal outputting unit 114, a point position monitoring unit 115, a window position monitoring unit 116, an image data storing unit 117, an image data generating unit 118, and an image signal outputting unit 119.

The history data storing unit 111 stores a notification information definition table showing the correspondence among categories of notification information, notification content IDs representing notification content, and display area IDs representing display areas. Also, the history data storing unit 111 stores a pointer position history table showing a display history of pointer positions indicated by the mouse 400 on the basic screen obtained by the pointer position monitoring unit 115. Furthermore, the history data storing unit 111 stores a window display frequency table showing display frequency information of a window obtained by the window position monitoring unit 116.

The notification information obtaining unit 112 obtains update information of the OS and applications operating in the information processing apparatus 100 via the network 500. Also, the notification information obtaining unit 112 obtains e-mail reception information and information about a usage status of hardware from the OS or application operating in the information processing apparatus 100. After obtaining notification information, the notification information obtaining unit 112 refers to the notification information definition table stored in the history data storing unit 111 so as to obtain the notification content ID of the notification information based on the category of the notification information. The notification information obtaining unit 112 outputs the notification content ID to the display area deciding unit 113.

The display area deciding unit 113 decides a display area on the monitor 200 of the message represented by the notification content ID received from the notification information obtaining unit 112. In the display area deciding unit 113, an administrator presets whether a display area of all or part of messages should be a fixed area. Then, the display area deciding unit 113 decides the display area by using any of the methods described below.

A first method is used in the case where setting is made to fix the display area of a message. In this case, the display area deciding unit 113 refers to the notification information definition table stored in the history data storing unit 111 and decides the display area at the position predetermined by the administrator.

The following second to fourth methods are used in the case where setting is made not to fix the display area of a message.

The second method is used in the case where a user is performing work on the basic screen by using the mouse 400. In this case, the display area deciding unit 113 determines an area as a target of user's operation in the basic screen based on a range where a pointer moves with reference to the pointer position history table stored in the history data storing unit 111, and then decides a display area by avoiding the determined area.

The third method is preferably used in the case where a user is not operating a window of the basic screen. In this case, the display area deciding unit 113 determines an area where window display frequency is low with reference to the window display frequency table stored in the history data storing unit 111, and decides the determined area to be an output area of a message. Alternatively, the display area deciding unit 113 may determine an area where no window is displayed before displaying a message and decide the determined area to be a display area.

The fourth method is used in the case where the information processing apparatus 100 is reproducing a moving image in a window whose ratio is higher than a threshold ratio with respect to the entire screen or in the entire screen. In this case, the display area deciding unit 113 obtains an area where change in the screen of the moving image is small from the image data generating unit 118 and decides this area to be an output area. In the case where a moving image is being reproduced in a window whose ratio is lower than the threshold ratio with respect to the entire screen, the third method is used.

Also, the display area deciding unit 113 divides the screen of the monitor 200 into a plurality of display areas and obtains information of the display areas based on display area IDs that are defined by being associated with the respective display areas. The display area deciding unit 113 outputs notification information data including the correspondence between the obtained notification content ID and display area ID to the control signal outputting unit 114.

The control signal outputting unit 114 converts the notification information data received from the display area deciding unit 113 to a control signal for the monitor 200. The control signal outputting unit 114 outputs the control signal to the monitor 200.

The pointer position monitoring unit 115 obtains the pointer position history table, which is history of pointer positions indicated by the mouse 400. The pointer position monitoring unit 115 stores the pointer position history table in the history data storing unit 111.

The window position monitoring unit 116 divides the output screen of the monitor 200 into a plurality of areas and obtains a window display frequency table showing window display frequency in the respective areas. The window position monitoring unit 116 stores the window display frequency table in the history data storing unit 111.

The image data storing unit 117 stores content data of still and moving images.

The image data generating unit 118 generates image data of an OS operation screen and a moving image to be displayed on the monitor 200 based on the content data stored in the image data storing unit 117. When a moving image is to be displayed, the image data generating unit 118 determines an area where change in the screen of the moving image is small and notifies the display area deciding unit 113 of the display area ID corresponding to this area. The image data generating unit 118 outputs the generated image data to the image signal outputting unit 119.

The image signal outputting unit 119 converts the image data obtained from the image data generating unit 118 to an image signal to be displayed on the monitor 200. The image signal outputting unit 119 outputs the image signal to the monitor 200.

The monitor 200 includes a display information storing unit 201, a control signal receiving unit 202, an image signal receiving unit 203, and an image signal outputting unit 204.

The display information storing unit 201 stores a message definition table showing the correspondence between notification content IDs and specific messages.

The control signal receiving unit 202 receives a control signal from the information processing apparatus 100. The control signal receiving unit 202 obtains notification information data from the received control signal and obtains a notification content ID and a display area ID. The control signal receiving unit 202 obtains a specific message indicated by the notification content ID with reference to the message definition table stored in the display information storing unit 201. Then, the control signal receiving unit 202 outputs data including the obtained message and the display area therefor to the image outputting unit 204.

The image signal receiving unit 203 receives an image signal from the image processing apparatus 100. The image signal receiving unit 203 outputs basic screen data to be browsed and operated by a user to the image outputting unit 204 based on the received image signal.

The image outputting unit 204 is a screen to display images. The image outputting unit 204 displays an OS screen as a basic screen and image content to be operated/browsed by a user based on the basic screen data from the image signal receiving unit 203. When receiving data including a message indicating notification information and a display area therefor from the control signal receiving unit 202, the image outputting unit 204 combines the basic screen with the message based on the data so as to perform overlay display.

Next, a description is given about message definition information that is preset in the information processing apparatus 100 and the monitor 200.

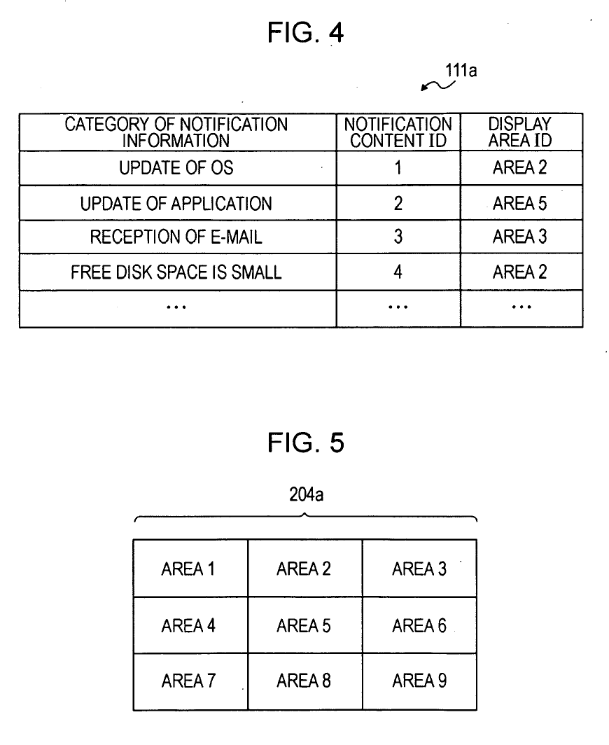

FIG. 4 illustrates an example of a data structure of the notification information definition table. The notification information definition table 111a is a table defining the correspondence among categories of notification information, notification content IDs, and display area IDs.

The notification information definition table 111a is provided with an item indicating categories of notification information, an item indicating notification content IDs, and an item indicating display area IDs. The pieces of information of the respective items horizontally aligned are mutually associated and comprise information about a piece of notification information.

In the item indicating categories of notification information, category names of notification information are set. In the item indicating notification content IDs, IDs to identify notification content are set. In the item indicating display area IDs, IDs to identify display areas are set. Here, the correspondence among the categories of notification information, notification content IDs, and display area IDs is predetermined between the information processing apparatus 100 and the monitor 200 by using, for example, a display driver to control the monitor 200 from the information processing apparatus 100. The display area IDs set here are used in the case where a message display area is fixed. In the case where a display area is not fixed, the display area IDs set in the notification information definition table 111a are not referred to, and a display area ID is decided by the display area deciding unit 113. Whether the display area should be fixed or not can be arbitrarily set by the administrator.

In the notification information definition table 111a, information indicating: the category of notification information is “update of OS”; the notification content ID is “1”; and the display area ID is “area 2” is set, for example. This indicates that the notification content ID of notification information categorized to “update of OS” is “1” and that the message corresponding to the notification information should be displayed at the center of the area indicated by the display area ID “area 2”.

FIG. 5 is a schematic diagram illustrating a specific example of screen division. An image outputting unit 204a is an example in which the image output area of the monitor 200 is divided into a plurality of areas and the respective areas are defined by display area IDs “area 1” to “area 9”.

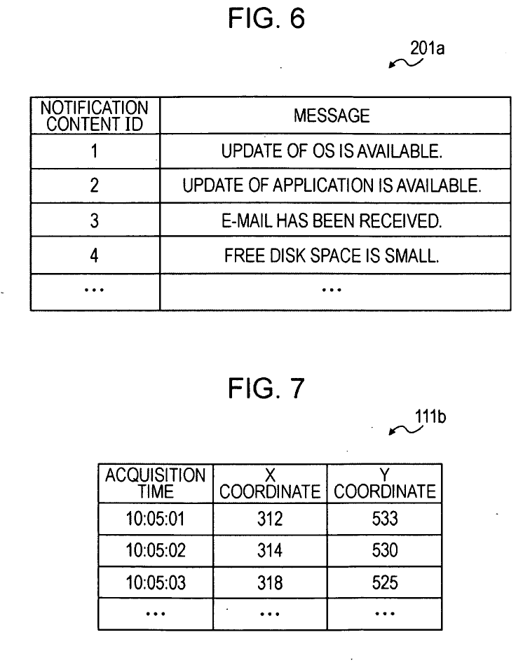

FIG. 6 illustrates an example of a data structure of the message definition table. The message definition table 201a is stored in the display information storing unit 201 of the monitor 200. The message definition table 201a is provided with an item indicating notification content IDs and an item indicating messages. The pieces of information of the respective items horizontally aligned are mutually associated and comprise information of a piece of notification content.

In the message definition table 201, information indicating: the notification content ID is “1”; and the message is “update of OS is available” is set, for example. This indicates that a specific message representing the notification information corresponding to the notification content ID “1” is “update of OS is available”.

Next, a description is given about history information obtained through operation by a user.

FIG. 7 illustrates an example of a data structure of the pointer position history table. The pointer position history table 111b is provided with an item indicating acquisition times, an item indicating X coordinates, and an item indicating Y coordinates. The pieces of information of the respective items horizontally aligned are mutually associated and comprise information of a pointer position.

In the item indicating acquisition times, the times when each data was obtained are set. In the item indicating X coordinates, the X coordinates of the pointer positions indicated by the mouse 400 on the screen of the monitor 200 are set. In the item indicating Y coordinates, the Y coordinates of the pointer positions indicated by the mouse 400 on the screen of the monitor 200 are set. The X and Y coordinates are simultaneously obtained at desired time intervals. In the pointer position history table 111b, information indicating: the acquisition time is “10:05:01”; the X coordinate is “312”; and the Y coordinate is “533” is set, for example. This indicates that the pointer of the mouse 400 was positioned at the position of (X, Y)=(312, 533) at the time “10:05:01”. If no operation by the mouse 400 occurs, e.g., such that there is no change of the X and Y coordinates, for a desired time period, the entire information set in the pointer position history table is deleted. That is, if no data exists in the pointer position history table, the display area deciding unit 113 can determine that the user is not performing an operation with the mouse 400. Even during a continuous operation with the mouse 400, data is deleted after sufficient time has elapsed. In this way, only the latest operation history can be stored and the amount of data to be stored can be limited.

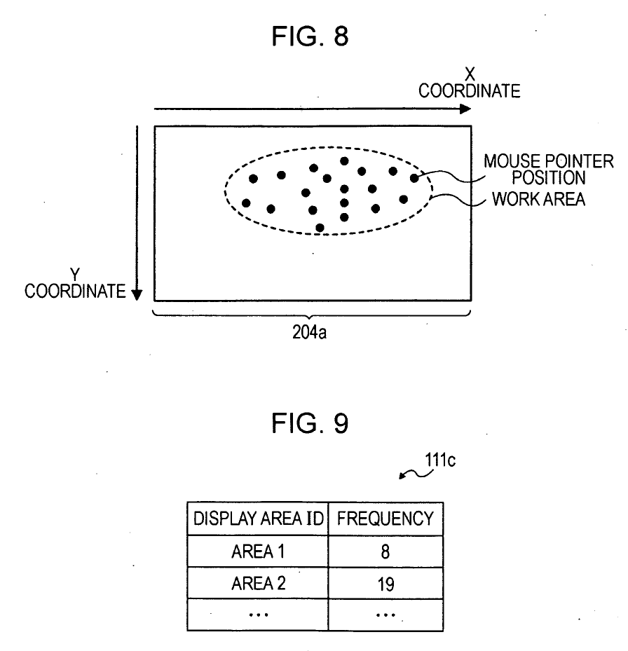

FIG. 8 is a schematic diagram illustrating the history of pointer positions of the mouse. As for coordinate axes of the screen, an X coordinate is horizontally set and a Y coordinate is vertically set, with the upper-right corner of the image outputting unit 204a being the origin. The pointer position monitoring unit 115 can obtain the coordinates of the mouse by using an API (Application Program Interface) of the OS, for example. The pointer position monitoring unit 115 monitors the pointer position of the mouse 400 at desired time intervals and obtains the positions thereof as the X and Y coordinates. Also, the pointer position monitoring unit 115 stores the information of the coordinates in the history data storing unit 111 in the form of the pointer position history table 111b. Then, the display area deciding unit 113 determines a work area of the user in the image outputting unit 204a to be an area including the positions where the pointer was positioned based on the pointer position history table 111b. The display area deciding unit 113 decides a message display area by avoiding this work area.

In the above-described example, the history of pointer positions is obtained based on the X and Y coordinates. Alternatively, the screen may be divided into a plurality of areas and the frequency of existence of the pointer in the respective areas in a given time period may be measured. In that case, the display area deciding unit 113 can determine the area where the frequency is the lowest and decide the area to be a message display area.

FIG. 9 illustrates an example of a data structure of the window display frequency table. The window display frequency table 111c is provided with an item indicating display area IDs and an item indicating frequencies. The pieces of information of the respective items horizontally aligned are mutually associated and comprise window display frequency information about an area.

In the item indicating display area IDs, IDs to identify display areas are set. In the item indicating frequencies, the number of times a work window was displayed in each area is set. The window position monitoring unit 116 increments the number of times by 1 every time the window is displayed in the corresponding area.

In the window display frequency table 111c, information indicating: the display area ID is “area 1”; and the frequency is “8” is set, for example. This indicates that a work window has been displayed “8” times in the area indicated by the display area ID “area 1” of the screen of the monitor 200.

The frequency information obtained in the window display frequency table 111c may be initialized to “0” at desired time intervals. In this way, a message display area is decided based on the display frequency in every desired time period.

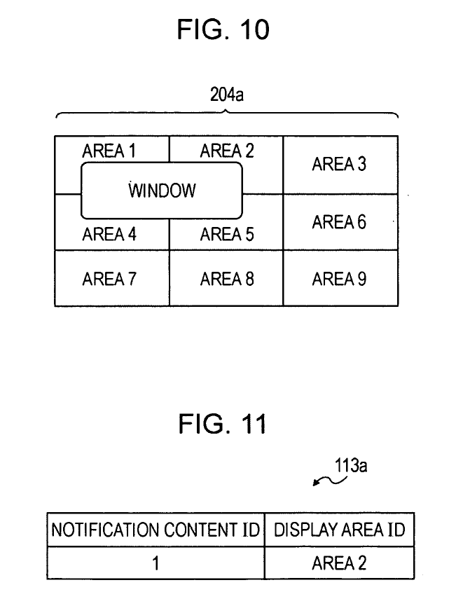

FIG. 10 is a schematic diagram illustrating an example in which a work window is displayed on the screen. FIG. 10 illustrates an example in which the window is displayed on areas 1, 2, 4, and 5 of the image outputting unit 204a. The window position monitoring unit 116 obtains the coordinates of the upper-left corner of the window and the coordinates of the opposing corner by using the API of the OS, thereby specifying the areas on which the window is displayed. In the case where the window is displayed on the above-described areas, the window position monitoring unit 116 increments the values of the frequency corresponding to “area 1”, “area 2”, “area 4”, and “area 5” in the window display frequency table 111c by 1. The display area deciding unit 113 determines the area where the window display frequency is the lowest based on the window display frequency table 111c and decides the area to be a message display area.

Next, a description is given about data indicating the correspondence between notification information and a display area for the information by the display area deciding unit 113.

FIG. 11 illustrates an example of a data structure of notification information data. The notification information data 113a is provided with an item indicating a notification content ID and an item indicating a display area ID. The pieces of information of the respective items horizontally aligned are mutually associated and comprise information about a piece of notification information.

In the item indicating a notification content ID, an ID representing a category of notification content is set. In the item indicating a display area ID, an ID representing a display area decided by the display area deciding unit 113 is set.

In the notification information data 113a, information indicating: the notification content ID is “1”; and the display area ID is “area 2” is set. This indicates that the notification content specified by the notification content ID “1” is output to the position indicated by the display area ID “area 2”.

In the item indicating the notification content ID, an ID to identify notification content is set. In the item indicating a message, a specific message about the notification content is set.

The control signal receiving unit 202 receives a control signal from the information processing apparatus 100 and obtains notification information data from the control signal. Then, the control signal receiving unit 202 obtains a specific message corresponding to the notification content ID indicated in the notification information data with reference to the message definition table 201a stored in the display information storing unit 201 and outputs the message to the image outputting unit 204.

In the above-described example, an ID indicating one of screen areas is specified as the position where a message is to be displayed. Alternatively, X and Y coordinates on the screen may be specified. In that case, frequency is obtained in units of coordinates in the window display frequency table 111c. Then, the coordinates indicating the position where a message is to be displayed is decided in the area where change in the screen is small based on the pointer position history table 111b or the window display frequency table 111c.

Next, a process in the information processing apparatus 100 having the above-described configuration is described in detail.

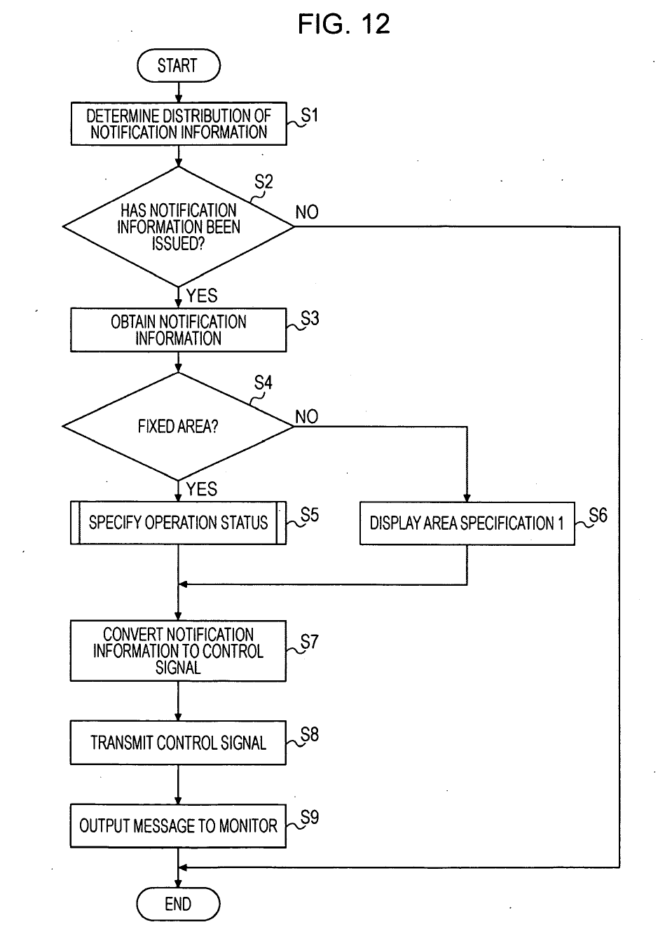

FIG. 12 is a first flowchart illustrating a procedure of message notification performed by the information processing apparatus 100. Hereinafter, the process illustrated in FIG. 12 is described in accordance with respective steps.

<Step S1> The notification information obtaining unit 112 determines whether notification information about the OS or application is newly distributed from a software vendor via the network 500. This determination is regularly performed in accordance with a schedule preset in the notification information obtaining unit 112 by an administrator, for example. Also, the notification information obtaining unit 112 waits for notification of e-mail reception information or information about a hardware usage status from the OS or application.

<Step S2> The notification information obtaining unit 112 determines whether notification information has been newly issued. If notification information has been issued, the process proceeds to step S3. If notification information has not been issued, the process ends.

<Step S3> The notification information obtaining unit 112 obtains notification information. The notification information obtaining unit 112 specifies a notification content ID corresponding to the obtained notification information and outputs the notification content ID to the display area deciding unit 113.

<Step S4> The display area deciding unit 113 receives the notification content ID from the notification information obtaining unit 112. The display area deciding unit 113 determines whether a message display area is set as a fixed area. If the message display area is not fixed, the process proceeds to step S6. If the message display area is fixed, the process proceeds to step S5.

<Step S5> The display area deciding unit 113 decides a message output area in accordance with a user operation status.

<Step S6> The display area deciding unit 113 specifies a display area ID corresponding to the obtained notification content ID with reference to the notification information definition table 111a stored in the history data storing unit 111. Then, the display area deciding unit 113 outputs the specified display area ID to the control signal outputting unit 114.

<Step S7> The display area deciding unit 113 obtains a work area where the user is performing an operation with reference to the pointer position history table 111b. Then, the display area deciding unit 113 decides a message output area by avoiding the obtained work area. The display area deciding unit 113 outputs the display area ID indicating the decided area to the control signal outputting unit 114.

<Step S8> The display area deciding unit 113 determines the area where the frequency of display of the work window is the lowest with reference to the window display frequency table 111c and decides the determined area to be a message output area. Then, the display area deciding unit 113 outputs the display area ID indicating the decided area to the control signal outputting unit 114.

<Step S9> The display area deciding unit 113 obtains the display area ID of the area where change in the screen is small in the moving image displayed from the image data generating unit 118. The display area deciding unit 113 outputs the notification content ID and the display area ID to the control signal outputting unit 114. Then, the control signal outputting unit 114 receives the notification content ID and the display area ID from the display area deciding unit 113. The control signal outputting unit 114 converts the notification content ID and the display area ID to a control signal for the monitor 200. Furthermore, the control signal outputting unit 114 outputs the control signal to the monitor 200. The monitor 200 receives the control signal from the control signal outputting unit 114, specifies the notification content and the display area based on the control signal, and displays the message about the notification information on the basic screen displayed on the image outputting unit 204 by overlay display.

Hereinafter, the above-described step S5 is described in detail.

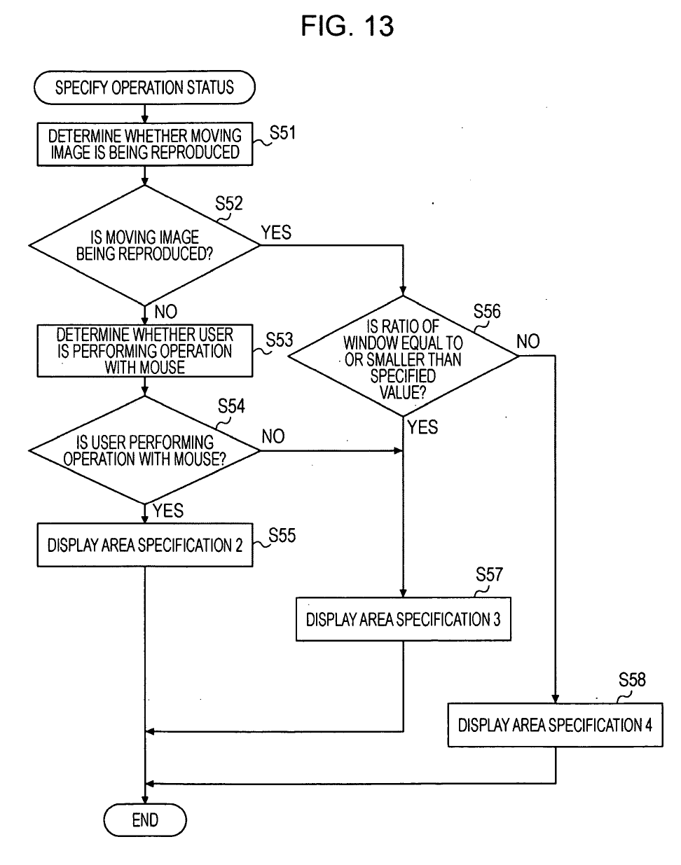

FIG. 13 is a second flowchart illustrating a procedure of message notification performed by the information processing apparatus. Hereinafter, the process illustrated in FIG. 13 is described in accordance with the respective steps.

<Step S51> The display area deciding unit 113 determines whether the information processing apparatus 100 is reproducing a moving image. The display area deciding unit 113 can obtain a reproducing status of a moving image from moving image reproducing software, for example.

<Step S52> The display area deciding unit 113 determines whether the information processing apparatus 100 is reproducing a moving image in accordance with the reproducing status of a moving image. If a moving image is not being reproduced, the process proceeds to step S53. If a moving image is being reproduced, the process proceeds to step S56.

<Step S53> The display area deciding unit 113 determines whether the user is performing an operation with the mouse 400 on the screen of the monitor 200.

<Step S54> The display area deciding unit 113 determines whether data exists in the pointer position history table 111b stored in the history data storing unit 111. If data exists, that is, if the user is performing an operation with the mouse 400, the process proceeds to step S55. If data does not exist, that is, if the user is not performing an operation with the mouse 400, the process proceeds to step S57.

<Step S55> The display area deciding unit 113 obtains the area where the user is performing an operation with reference to the pointer position history table 111b stored in the history data storing unit 111. Then, the display area deciding unit 113 decides a message output area by avoiding the obtained area. The display area deciding unit 113 outputs the display area ID indicating the specified area to the control signal outputting unit 114.

<Strep S56> The display area deciding unit 113 determines whether the ratio of the window where a moving image is being reproduced with respect to the entire screen is equal to or smaller than a specified value. If the ratio is equal to or smaller than the specified value, the process proceeds to step S57. If the ratio is larger than the specified value (including the case where a moving image is reproduced on the entire screen), the process proceeds to step S58.

<Step S57> The display area deciding unit 113 determines the area where the work window is displayed least frequently with reference to the window display frequency table 111c, and decides the determined area to be a message display area. Then, the display area deciding unit 113 outputs the display area ID indicating the specified area to the control signal outputting unit 114.

<Step S58> The display area deciding unit 113 obtains the display area ID of the area where change in the screen is small in the displayed moving image from the image data generating unit 118. The display area deciding unit 113 outputs the notification content ID and the display area ID to the control signal outputting unit 114.

In step S57, the output area of the window may be determined before displaying a message and the output area of the message may be decided by avoiding the position thereof.

In this way, the information processing apparatus 100 decides the output area on the screen of the monitor 200 of a message in accordance with a user's usage status before providing the message to the user. The information processing apparatus 100 determines an area outside the area where the user is performing an operation or an area where change in the screen of a moving image is small in the screen of the monitor 200 to be an output area, and displays a message on this area. Accordingly, interruption of operation by the user due to display of a message can be suppressed.

Next, a description is given about a method for determining an area where change in the screen caused by the image data generating unit 118 is small when a moving image is being reproduced on the monitor 200. Here, assume that the moving image is recorded in the MPEG (Motion Picture Experts Group) method.

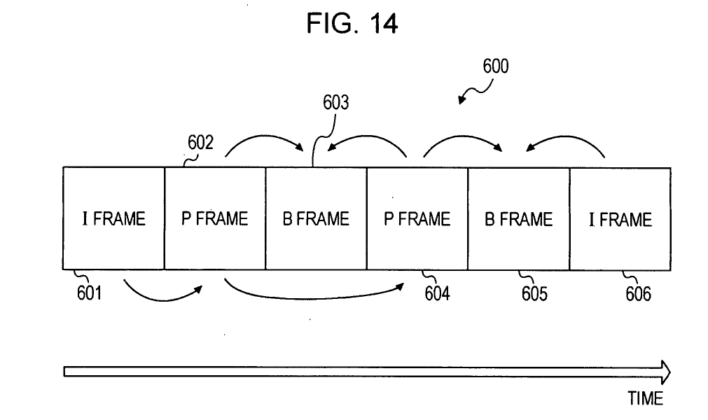

FIG. 14 is a schematic diagram illustrating an example of a frame structure of the MPEG. A frame group 600 includes an I frame 601, a P frame 602, a B frame 603, a P frame 604, a B frame 605, and an I frame 606, which are arranged in time series. Here, a moving image based on the MPEG is composed of a plurality of frames (still images). By recording those frames by using differences between temporally-adjoining frames, the amount of entire data is reduced. The I frame is a frame containing the entire still image at a certain instance of the moving image. The P frame is a frame containing the difference from a temporally-preceding I frame or P frame. For example, the P frame 602 is a frame containing the difference from the I frame 601. The B frame is a frame containing the differences from temporally-preceding and temporally-following I frame or P frame. For example, the B frame 603 is a frame containing the differences from the P frames 602 and 604. The amount of information in units of frames is the largest in the I frame, the second largest in the P frame, and the smallest in the B frame.

The image data generating unit 118 divides each frame into a plurality of areas and obtains the area where change is the smallest on average in a given time period among the respective areas. For example, the image data generating unit 118 divides each frame into nine areas, and determines the area where change in image is the smallest on average in the given time period among the nine areas. The amount of change in image can be determined by obtaining the amount of information in each area of each frame and by determining the amount of data contained in the area. After determining the area where change in image is the smallest on average in the given time period, the image data generating unit 118 outputs the display area ID corresponding to the determined area to the display area deciding unit 113.

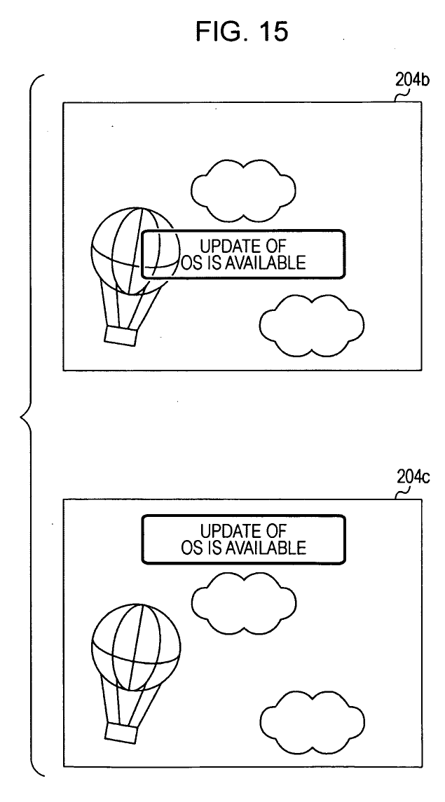

FIG. 15 is a schematic diagram illustrating specific examples in which a message is displayed at a fixed position. An image outputting unit 204b shows the case where a message is displayed at the center of the screen. An image outputting unit 204c shows the case where a message is displayed at an upper portion of the screen. By displaying the message at the upper portion of the screen as in the image outputting unit 204c, the same output as display of caption during television viewing can be realized while a moving image is being reproduced on the entire screen. In this way, the message is displayed at a familiar position, so that the user can easily recognize the message. The message display area may be arbitrarily set by the administrator in accordance with the message to be displayed.

Hereinafter, an example of the case where the message display area is not fixed and is determined in accordance with a usage status is described.

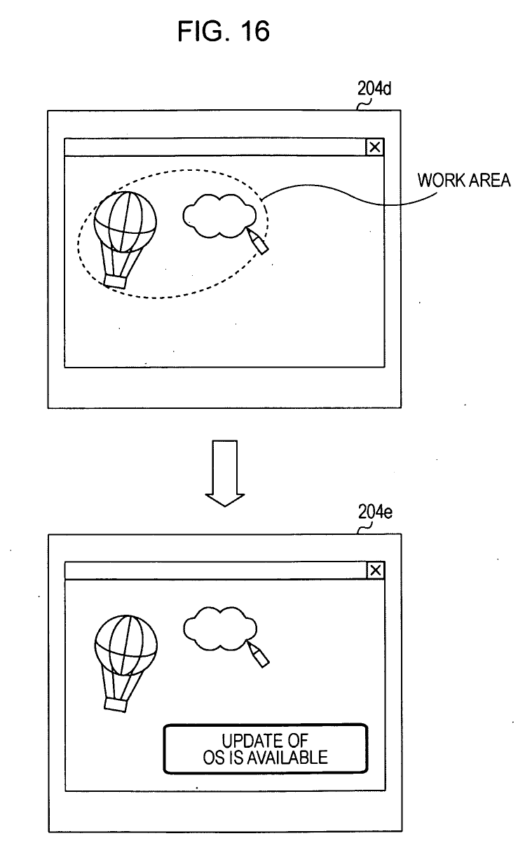

FIG. 16 is a schematic diagram illustrating a specific example in which a message is displayed while avoiding a user's work area. An image outputting unit 204d shows the case where a work area is specified before a message is displayed during drawing by drawing software. The work area is specified based on the history of positions where the mouse 400 is moved during a drawing operation. The message output area is decided by avoiding the work area. An image outputting unit 204e shows an example in which a message is displayed in the output area decided in this way. By displaying the message by avoiding the user's work area, interruption of operation by the user due to display of the message can be suppressed.

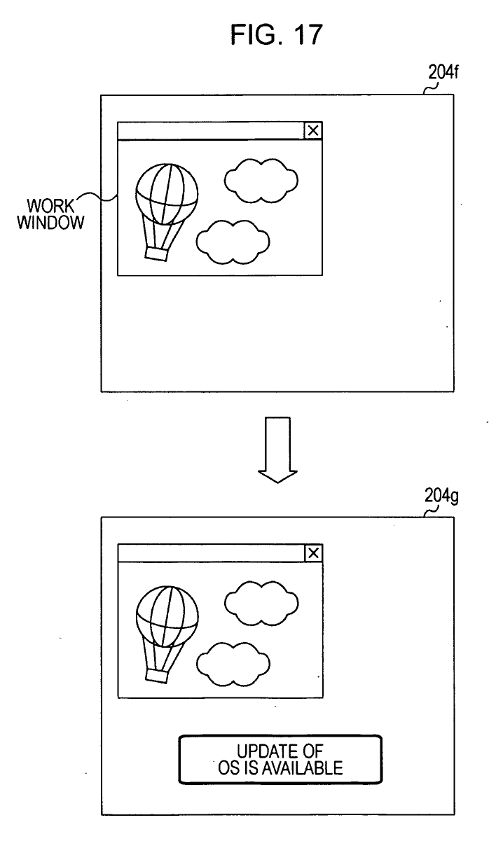

FIG. 17 is a schematic diagram illustrating a specific example of the case where a message is displayed in an area where window display frequency is low. In an image outputting unit 204f, a work window of drawing software is open but an operation with the mouse 400 is not performed. In this case, the display area deciding unit 113 determines the area where display frequency of the work window in the image outputting unit 204f is the lowest with reference to the window display frequency table 111c and decides the determined area to be a message output area. An image outputting unit 204g is an example in which a message is displayed in the output area decided in this way. Alternatively, the display area deciding unit 113 may determine a display area of the window displayed at the time of output of a message and may display the message by avoiding the display area.

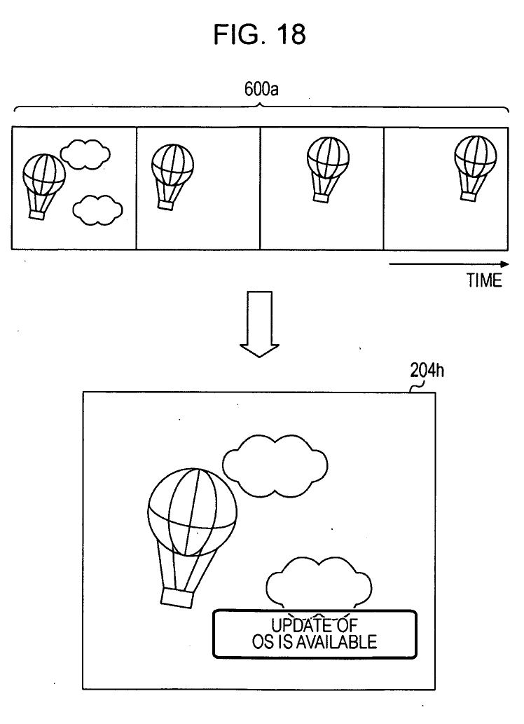

FIG. 18 is a schematic diagram illustrating a specific example of the case where a message is displayed on the screen where a moving image is being reproduced. Moving image information is recorded in the MPEG method. A frame group 600a is a frame structure of the moving image. The image data generating unit 118 divides the frame group 600a into a plurality of areas. Then, the image data generating unit 118 obtains the area where change in image is the smallest on average in the frames included in a certain time period. In the example illustrated in FIG. 18, the image data generating unit 118 determines that the area where change in image is the smallest on average is the lower-right area of the screen. An image outputting unit 204h is an example in which a message is displayed based on this result.

The message is displayed on the screen such that the basic screen can be seen through the area around characters included in the message. Thus, even when the user is operating the basic screen, information can be provided to the user without covering the operated screen. That is, the user can continue the operation with reference to the basic screen seen through the area around the characters. Alternatively, the message may be highlighted relative to the surrounding image, and the area around the characters of the message may be nontransparent or semitransparent so that the user can recognize the message more easily.

If the information processing apparatus 100 performs a process related to a notification upon click of the displayed message with the mouse 400, user-friendliness is enhanced.

Furthermore, the displayed message is automatically erased from the screen after a certain time period. If the user wants to immediately erase the message, the user may erase the message by clicking it.

As described above, the position for displaying a message can be changed in accordance with an operation status of the screen by the user. When a moving image is being reproduced, the message is output to an area where change in the screen of the moving image is small. Accordingly, the message can be displayed so that the user can easily recognize the message without interrupting operation/browse of the screen by the user. Furthermore, the size or color of characters may be changed in accordance with the message to be provided in order to enhance the viewability for the user. Furthermore, sound may be output from a speaker or the like connected to the information processing apparatus 100 at the same time when the message is displayed in order to notify the user that the message exists.

As described above, the information processing apparatus 100 decides an output area of a message in the screen area of the monitor 200 before providing the message to the user. The information processing apparatus 100 determines an area outside the area where the user is performing an operation or an area where change in the screen of a moving image is small in the screen area of the monitor 200 to be the output area, and decides the area to be a message display area. Accordingly, interruption of an operation by the user due to display of a message can be suppressed.

The information processing apparatus, the message providing method, and the message providing program have been described above based on the embodiment illustrated in the drawings. However, the present technique is not limited the above-described embodiment, and the configuration of each unit can be replaced by an arbitrary configuration having the same function. Also, another arbitrary configuration or step may be added. Also, two or more arbitrary configurations (features) in the above-described embodiment may be combined.

The above-described processing function can be realized by a computer. In that case, a program describing a process of the function that should be provided in the information processing apparatus 100 is provided. The above-described processing function is realized in the computer by allowing the computer to execute the program.

The program describing the process can be recorded on a computer-readable recording medium. Examples of the computer-readable recording medium include a magnetic recording device, an optical disc, a magneto-optical recording medium, and a semiconductor memory. Examples of the magnetic recording device include an HDD, a flexible disk (FD), and a magnetic tape (MT). Examples of the optical disc include a DVD (Digital Versatile Disc), a DVD-RAM, a CD-ROM (Compact Disc-Read Only Memory), and a CD-R (Recordable)/RW (ReWritable). An example of the magneto-optical recording medium is an MO (Magneto-Optical disk).

When the above-described program is to be distributed, portable recording media, such as DVDs or CD-ROMs, carrying the program are sold. Alternatively, the program may be stored in a server computer and may be transferred to other computers from the server computer via a network.

The computer executing the above-described program stores the program that is recorded on a portable recording medium or that is transferred from a server computer in a storage device of the computer. Then, the computer reads the program from the storage device and performs a process in accordance with the program. The computer may read the program directly from the portable recording medium and perform a process in accordance with the program. Also, every time a program is transferred from a server computer, the computer may sequentially perform processes in accordance with the received programs.

What is claimed is:

1. An information processing apparatus for selectively locating an overlaid message on a screen of a display apparatus, the information processing apparatus comprising:
obtaining means for obtaining notification information that includes an indication of the content of the message to be displayed on the screen of the display apparatus;
deciding means for adaptively selecting an area of the screen to serve as an announcement area for eventual depiction of the message, a location of the announcement area being such that depiction of the message therein is less-likely to disrupt a viewer of the screen than depiction of the message in a work area of the screen for which disruption of the viewer would be more likely; and
control means for outputting, to the display apparatus, a control signal indicating the content of the message to be displayed in the display apparatus and indicating the announcement area of the screen.

2. The information processing apparatus according to claim 1, further comprising:
pointer monitoring means for monitoring positions of a pointer displayed on the screen to determine pointer display frequencies relative to areas of the screen, respectively;
wherein a display frequency of the pointer in the announcement area is relatively lower than a display frequency of the pointer in the work area.

3. The information processing apparatus according to claim 1, further comprising:
window monitoring means for monitoring positions of windows displayed on the screen to determine window-location display frequencies relative to areas of the screen, respectively;
wherein a display frequency of windows in the announcement area is relatively lower than a display frequency of windows in the work area.

4. The information processing apparatus according to claim 1, further comprising:
motion monitoring means for monitoring a drawing area on the screen where a moving image is being depicted; and
recognition means for recognizing at least one less-dynamic area within the drawing area in which the moving image exhibits a relatively smaller degree of change as compared to at least one more-dynamic area within the drawing area in which the moving image exhibits a relatively larger degree of change;
wherein the deciding means 1s further operable for selecting the announcement area to be one from among of the least one less-dynamic area.

5. The information processing apparatus according to claim 1, wherein:
the display apparatus is operatively coupled to an information processing apparatus;
the content of the message pertains to update information regarding software loaded on the information processing apparatus; and
the notification information is received from another information processing apparatus via a network to which the information processing apparatus is operatively coupled.

6. A computer-implemented method for selectively locating an overlaid message on a screen of a display apparatus, the method comprising:
obtaining notification information that includes an indication of the content of the message to be displayed on a screen of the display apparatus;
adaptively selecting an area of the screen to serve as an announcement area for eventual depiction of the message, a location of the announcement area being such that depiction of the message therein is less-likely to disrupt a viewer of the screen than depiction of the message in a work area of the screen for which disruption of the viewer would be more likely; and
outputting, to a display apparatus, a control signal indicating the content of the message to be displayed and indicating the announcement area of the screen.

7. The method according to claim 6, further comprising:
monitoring positions of a pointer displayed on the screen to determine pointer display frequencies relative to areas of the screen, respectively;
wherein a display frequency of the pointer in the announcement area is relatively lower than a display frequency of the pointer in the work area.

8. The method according to claim 6, further comprising:
monitoring positions of windows displayed on the screen to determine window-location display frequencies relative to areas of the screen, respectively;
wherein a display frequency of windows in the announcement area is relatively lower than a display frequency of windows in the work area.

9. The method according to claim 6, further comprising:
monitoring a drawing area on the screen where a moving image is being depicted;
recognizing at least one less-dynamic area within the drawing area in which the moving image exhibits a relatively smaller degree of change as compared to at least one more-dynamic area within the drawing area in which the moving image exhibits a relatively larger degree of change;
wherein the announcement area is selected from the at least one less-dynamic area.

10. The method according to claim 6, wherein:
the display apparatus is operatively coupled to an information processing apparatus;
the content of the message pertains to update information regarding software loaded on the information processing apparatus; and
the notification information is received from another information processing apparatus via a network to which the information processing apparatus is operatively coupled.

11. The method according to claim 6, further comprising:
controlling the display apparatus to overlay the message on the screen in the announcement area thereof.

12. A computer-readable recording medium comprising computer-executable instructions for performing a method, execution of which by a computer facilitates selectively locating an overlaid message on a screen of a display apparatus, the method including:
obtaining notification information that includes an indication of the content of the message to be displayed on a screen of the display apparatus;
adaptively selecting an area of the screen to serve as an announcement area for eventual depiction of the message, a location of the announcement area being such that depiction of the message therein is less-likely to disrupt a viewer of the screen than depiction of the message in a work area of the screen for which disruption of the viewer would be more likely; and
outputting, to a display apparatus, a control signal indicating the content of the message to be displayed and indicating the announcement area of the screen.

13. The computer-readable medium according to claim 12, wherein the computer-executed method further includes:
monitoring positions of a pointer displayed on the screen to determine pointer display frequencies relative to areas of the screen, respectively;
wherein a display frequency of the pointer in the announcement area is relatively lower than a display frequency of the pointer in the work area.

14. The computer-readable medium according to claim 12, wherein the computer-executed method further includes:
monitoring positions of windows displayed on the screen to determine window-location display frequencies relative to areas of the screen, respectively;
wherein a display frequency of windows in the announcement area is relatively lower than a display frequency of windows in the work area.

15. The computer-readable medium according to claim 12, wherein the computer-executed method further includes:
monitoring a drawing area on the screen where a moving image is being depicted;
recognizing at least one less-dynamic area within the drawing area in which the moving image exhibits a relatively smaller degree of change as compared to at least one more-dynamic area within the drawing area in which the moving image exhibits a relatively larger degree of change;
wherein the announcement area is selected from the at least one less-dynamic area.

16. The computer-readable medium according to claim 12, wherein:
the display apparatus is operatively coupled to an information processing apparatus;
the content of the message pertains to update information regarding software loaded on the information processing apparatus; and
the notification information is received from another information processing apparatus via a network to which the information processing apparatus is operatively coupled.

18. The computer-readable medium according to claim 12, wherein the method further includes:
controlling the display apparatus to overlay the message on the screen in the announcement area thereof.
